(19) United States
(12) Patent Application Publication
(10) Pub. No.: US 2018/0126888 A1
(43) Pub. Date: May 10, 2018

(54) Head Restraint

(71) Applicant: Joseph J. Sugameli, Sterling Heights, MI (US)

(72) Inventor: Joseph J. Sugameli, Sterling Heights, MI (US)

(21) Appl. No.: 15/811,483

(22) Filed: Nov. 13, 2017

Related U.S. Application Data
(60) Provisional application No. 62/420,537, filed on Nov. 10, 2016.

(51) Int. Cl. B60N 2/885; B60N 2/806; B60N 2/28

(52) U.S. Cl. CPC B60N 2/885; B60N 2/2851; B60N 2/806

(57) ABSTRACT

A head restraint system contains a head restraint for fitting about the head of a user, and a first restraint and a second restraint for restraining the movement of the head restraint when placed about the head of a user. The head restraint may be fixed to a fixed part of a vehicle such as a seat, thereby limiting the movement of the head of a user when employed.

### CROSS-REFERENCE TO RELATED APPLICATIONS

This application claims the benefit of U.S. Provisional Application Ser. No. 62/420,537 having a filing date of Nov. 10, 2016, the contents of which are herein incorporated by reference in its entirety.

### BACKGROUND OF THE INVENTION

A head restraint for positioning the head of a traveler, even when sleeping, is provided. Oftentimes, as an occupant of a vehicle, such as an automobile or an airplane for example, falls asleep while travelling, the head becomes relatively unsupported. As a result, the head may be canted toward one or the other side of the occupant and may strain the neck. Furthermore, from a safety enhancement standpoint, it is desirable to ensure that the head is maintained in a certain position to better absorb any energy from bumps in the road or perhaps, from an impending or actual accident. Accordingly, the present invention improves the state of the art by providing a head restraint for a traveler that provides a substantial improvement in the support of the head of the occupant.

### SUMMARY OF THE INVENTION

The above-referenced concerns are resolved by providing a head restraint system as described herein. The various embodiments of the system include a head restraint frame containing a first side for fitting to a first side of the face of the user and a second side for fitting to a second side of the face of the user; a first restraint attached to the first side of the frame and to an associated head rest; and a second restraint attached to the second side of the frame and to the associated head rest. In general, the head restraint system is attached to an associated seat, and more particularly, to an upper portion of an associated seat.

### BRIEF DESCRIPTION OF THE DRAWINGS

FIG. 1 is a perspective view of a first embodiment of the present invention.

FIG. 2 is a front view of the embodiment of FIG. 1.

FIG. 3 is a perspective view of a seat and neck pad for a second embodiment of the present invention.

FIG. 4 is a perspective view of an open mask and head restraint for a second embodiment of the present invention.

### DETAILED DESCRIPTION OF THE PREFERRED EMBODIMENTS

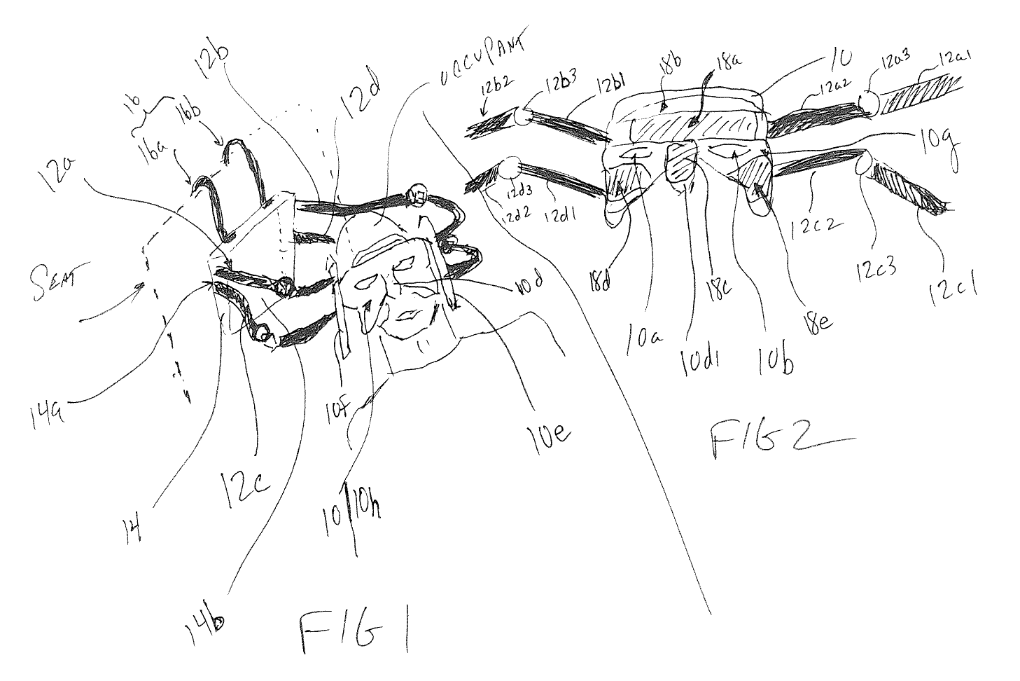

In a first embodiment shown in FIGS. 1 and 2, a head restraint system 100 contains a head restraint or mask 10. The head restraint or mask 10 contains two slits or apertures 10a and 10b, in a median or other portion 10c of the mask 10, and thereby facilitates the vision of the occupant through the two apertures 10a, 10b. The mask/head restraint 10 is designed as a mask not only for comfort, but also for the enjoyment of an infant or toddler that might use the head restraint 10. The mask 10 contains an inner portion 10g and an outer portion 10h, and may be made in a known manner and from materials typically used for masks, such as plastics, cloth, or other synthetic material such as a nylon or polyester-based material. The mask should preferably be flexible and yet contain a moderate amount of rigidity, again, much the same as is known in the mask-making art. A nose protrusion 10d may be formed in the mask if desired, and may provide a third aperture or pair of apertures 10d1 for respiration through the mask 10 and nose of the occupant. A first side portion or wing 10e of the mask 10 is formed on the side of the mask and is relatively rigid, thereby providing leverage when tightening an associated strap 12a as explained below. A second side portion or wing 10f of the mask 10 is formed on a side of the mask opposite to the first wing 10e, and is also relatively rigid, thereby providing leverage when tightening an associated second strap 12b as explained below.

A back portion 14 of the head restraint 10 may be formed from a soft but firm material, such as memory foam or perhaps as an inflatable cushion, for resting the occupant's head there against. At least one hook 16, and preferably a pair of hooks 16a and 16b, may be fastened to and extend from a rear side 14a of the back portion 14, or alternatively, may be fastened to and extend from a front side 14b of the back portion 14, whereby the hooks 16 may be saddled or placed over a top portion of a vehicular seat.

A first adjustable strap 12a may contain a first portion 12a1 fixed to the back portion 14 and a second portion 12a2 fixed to the first wing 10e above the eye aperture 10a. A latching mechanism 12a3 is fixed to the free ends of strap portions 12a1 and 12a2, and may for example, contain a quick disconnect mechanism for easy connection and disconnection of strap portions 12a1 and 12a2. A second adjustable strap 12b may contain a third portion 12b1 fixed to the back portion 14, on a side opposite to the location of the first portion 12a1, and a fourth portion 12b2 fixed to the second wing 10f above the eye aperture 10b. A latching mechanism 12b3 is fixed to the free ends of strap portions 12b1 and 12b2, and may for example, also contain a quick disconnect mechanism for easy connection and disconnection of strap portions 12b1 and 12b2.

If desired, a third adjustable strap 12c may contain a fifth portion 12c1 fixed to the back portion 14 and a sixth portion 12c2 fixed to the first wing 10e below the eye aperture 10a. A latching mechanism 12c3 is fixed to the free ends of strap portions 12c1 and 12c2, and may for example, contain a quick disconnect mechanism for easy connection and disconnection of strap portions 12c1 and 12c2. If desired, a fourth adjustable strap 12d may contain a seventh portion 12d1 fixed to the back portion 14, on a side opposite to the location of the first portion 12c1, and an eighth portion 12d2 fixed to the second wing 10f below the eye aperture 10b. A latching mechanism 12d3 is fixed to the free ends of strap portions 12d1 and 12d2, and may for example, also contain a quick disconnect mechanism for easy connection and disconnection of strap portions 12d1 and 12d2.

It will be appreciated that the first and third straps 12a and 12c taken alone or together may be referred to as a first restraint 22. A first side 10e of the mask 10 is fixed to the first restraint 22 whereby the first side 10e may be snugged up against the face of the user during use of the head restraint/mask 10. In the same way, the second and fourth straps 12b and 12d taken alone or together may be referred to as a second restraint 24. A second side 10f of the mask 10 is fixed to the second restraint 24 whereby the second side 10f may be snugged up against the face of the user during use of the head restraint/mask 10.

A first cushion portion 18a may be formed on the inner portion 10g of the mask 10, in an area that will contact the forehead of the occupant when the mask is strapped to the occupant. If desired, a rigid member 18b may first be fixed to the inner portion 10g of the mask 10 and then the first cushion portion 18a may be fixed to the rigid member 18b, such that the rigid member 18b is sandwiched between the inner portion 10g and the first cushion portion 18a. A second cushion portion 18c may be formed on the inner portion 10g of the mask 10, in an area that will contact the bridge of the nose of the occupant when the mask is strapped to the occupant. A third cushion portion 18d may be formed on the inner portion 10g of the mask 10, in an area that will contact the left cheek of the occupant when the mask is strapped to the occupant. A fourth cushion portion 18e may be formed on the inner portion 10g of the mask 10, in an area that will contact the right cheek of the occupant when the mask is strapped to the occupant. The various cushion portions may be formed separately from each other, or, if desired, the cushion portion may be one monolithic section of foam that is shaped to accommodate the shape of the inner portion 10g of the mask 10. The various cushion portions may be formed from a firm but soft material such as memory foam.

In operation, the mask 10 may be attached to the back portion 14 by first attaching straps 12a and 12c, or, straps 12b and 12d. on either strap 12a or 12b, by connecting the respective latching mechanisms. A pair of the straps 12a and 12c or 12b and 12d is left disconnected so that the mask 10 may be placed over the eyes and nose and face of the occupant. Once the mask is in place the remaining straps are connected by securing the respective latching mechanisms. If desired, the straps 12a-12d may be resiliently stretched to accommodate different sizes of a head, or, the straps 12a-12d may be adjustable in length by modifying the length of the strap in a known way.

As the mask 10 is tightened over the face of the occupant, leverage is provided by the first and second rigid wings 10e and 10f, as they are conformed to the sides and cheeks of the face of the occupant.

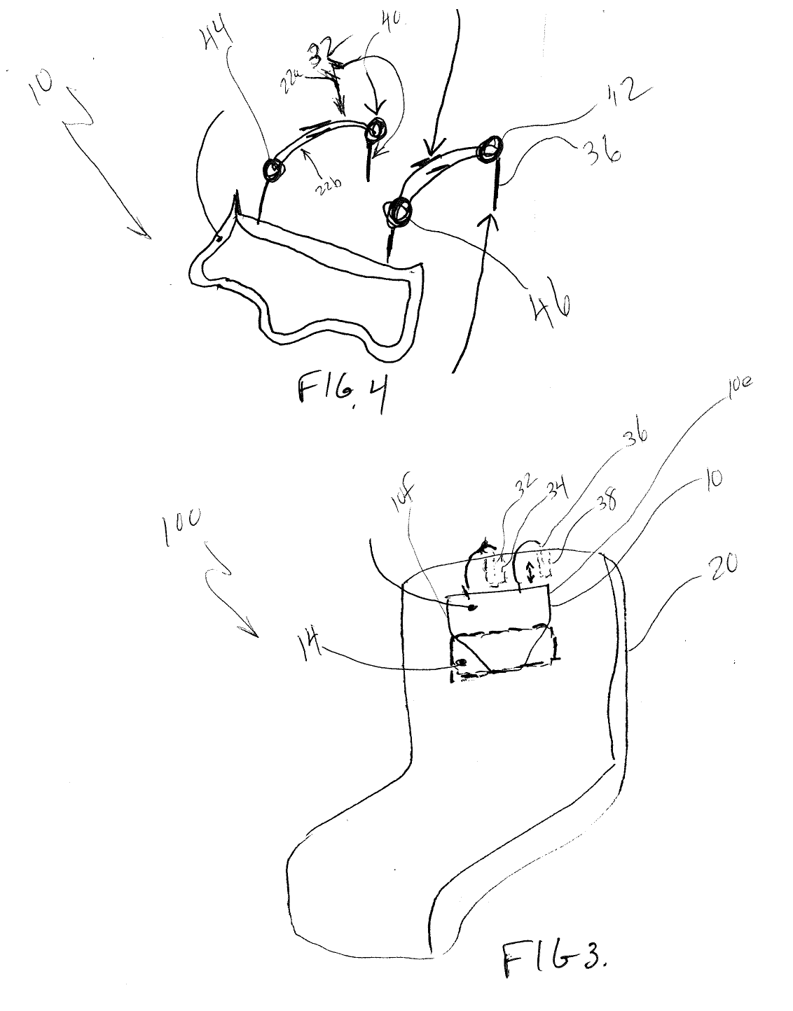

In a second embodiment of a head restraint system 100 as shown in FIGS. 3-4, an exemplary seat 20 employs a head restraint 10. Accordingly, a head restraint system 100 may contain a seat 20 for housing or fixing a head restraint 10 thereto. An open mask or head restraint 10 is provided and fixed to the rear 20a of the seat 20. In contrast to the first embodiment, the open mask provides unobstructed viewing for the user of the head restraint 10, and may be formed in the shape of underwater goggles, for example. A first restraint 22 is fixed to a first side 26 of the mask/head restraint 10 for biasing the mask 10 against a first side of the face of the user (not shown). A second restraint 24 is fixed to a second side 28 of the mask/head restraint 10 for biasing the mask 10 against a second side (opposite to the first side) of the face of the user (not shown).

A first restraint member 22a and a second restraint member 22b combined with the first restraint member 22a, form the first restraint 22. The first and second restraint members may for example, be slidably engaged with each other wherein one of the two members is telescoped within the other member to permit adjustment of the length of the first restraint 22. In the same way, a third restraint member 24a and a fourth restraint member 24b combined with the third restraint member 24a, form the second restraint 24. The third and fourth restraint members may for example, be slidably engaged with each other wherein one of the two members is telescoped within the other member to permit adjustment of the length of the second restraint 24.

A first hook member 32 is contiguous with and connected to first restraint member 22a and may be removably fixed to the back of the seat 20, by sliding the first hook member 32 within a first sleeve 34 attached or fixed to the back of the seat, thereby holding the head restraint 10 in place. Along with the first hook member 32, a second hook member 36 is contiguous with and connected to third restraint member 24a and may be removably fixed to the back of the seat 20, by sliding the second hook member 36 within a second sleeve 38 attached or fixed to the back of the seat, again thereby holding head restraint 10 in place. A first hinge 40 is provided on the first restraint 22 and provides pivoting of the head restraint above the sleeve 34, for docking or removing the mask 10 upon the face of the user. In the same way, and in cooperation with the first hinge 40, a second hinge 42 is provided on the second restraint 24 and provides pivoting of the head restraint 10 above the second sleeve 38, for docking or removing the mask 10 upon the face of the user. A third hinge 44 may if desired be provided on the first restraint 22 to pivot the mask 10 above the face of the user. A fourth hinge 46 may if desired be provided on the second restraint 24 to pivot the mask 10 above the face of the user, in conjunction with hinge 44.

The various components of the head restraint system 100 may be formed by known manufacturing and/or molding processes, such as foam mold processes or injection mold processes. The various components may be made from plastic, foam, or other suitable materials. The seat 20 may be formed as known in the art. Accordingly, seats for infant carriers, for automotive application, and/or for aeronautic application, but no limited thereto, are contemplated as useful in the present invention.

It will be understood that the foregoing descriptions of various embodiments of the present invention is for illustrative purposes only. As such, the various structural and operational features herein disclosed are susceptible to a number of modifications, none of which departs from the scope of the present invention as defined in the appended claims.

What is claimed is:

1. A head restraint system comprising:
a seat;
a head restraint fixed to the seat, said head restraint comprising a first side and a second side opposite the first side, and configured to fit about the head of a user;
a first restraint fixed to the first side; and
a second restraint fixed to the second side, wherein said first and second restraints bias the head restraint against a face of a user.

2. The head restraint system of claim 1 wherein said first restraint comprises at least one elastic band, and, said second restraint comprises at least one elastic band.

3. The head restraint system of claim 2 wherein said first restraint comprises two elastic bands, and, said second restraint comprises two elastic bands, and each of said first and second restraints is adjustable.

4. The head restraint system of claim 1 wherein said head restraint is a mask.

5. The head restraint system of claim 1 wherein said head restraint has unobstructed vision.

6. The head restraint system of claim 1 further comprising:
a first hook member integral to said first restraint and fixed to a rear of the seat, and, a second hook member integral to said second restraint and fixed to the rear of the seat.

7. The head restraint system of claim 6 further comprising a first sleeve fixed to the rear of the seat for receipt of said first hook member, and, further comprising a second sleeve fixed to the rear of the seat for receipt of said second hook member.

8. The head restraint system of claim 6 further comprising a first hinge member adjacent said first hook member, and, a second hinge member adjacent said second hook member, said first and second hinge members cooperating to pivot said head restraint about said hook members.

9. The head restraint system of claim 6 further comprising a third hinge member adjacent to said head restraint, and, a fourth hinge member adjacent to said head restraint, said third and fourth hinge members cooperating to pivot said head restraint.

10. The head restraint system of claim 1 wherein:
said first restraint comprises a first restraint member slidably engaged within a second restraint member; and
said second restraint comprises a third restraint member slidably engaged within a fourth restraint member.

11. A head restraint system comprising:
a seat;
an adjustable head restraint fixed to the seat, said head restraint comprising a first side and a second side opposite the first side, and configured to fit over the head of a user;
an adjustable first restraint fixed to the first side; and
an adjustable second restraint fixed to the second side, wherein said first and second restraints bias the head restraint against a face of a user.

12. The head restraint system of claim 11 wherein said adjustable first and second restraints are pivotally operable about said seat.

13. The head restraint system of claim 11 wherein:
said first restraint comprises a first restraint member slidably engaged within a second restraint member; and
said second restraint comprises a third restraint member slidably engaged within a fourth restraint member.

14. A safety device comprising:
a head restraint comprising a first side and a second side opposite the first side, and configured to fit about a head of a user and restrain the movement of the head;
a first restraint fixed to the first side; and
a second restraint fixed to the second side, wherein said first and second restraints bias the head restraint against a face of a user, and limit movement thereof.
